(19) United States
(12) Patent Application Publication
(10) Pub. No.: US 2017/0167331 A1
(43) Pub. Date: Jun. 15, 2017

(54) ENGINE VENTILATION SYSTEM

(71) Applicants: Hyundai Motor Company, Seoul (KR); Kia Motors Corporation, Seoul (KR)

(72) Inventors: Dongheon PARK, Seongnam-si (KR); Woong KIM, Hwaseong-si (KR)

(73) Assignees: Hyundai Motor Company, Seoul (KR); Kia Motors Corporation, Seoul (KR)

(21) Appl. No.: 15/353,605

(22) Filed: Nov. 16, 2016

(30) Foreign Application Priority Data
Dec. 11, 2015 (KR) 10-2015-0177477

(51) Int. Cl. F01M 13/04; F02B 75/18

(52) U.S. Cl. CPC F01M 13/04; F02B 75/18; F01M 2013/0494; F01M 2013/005

(57) ABSTRACT

An engine ventilation system may include a main blow-by passage formed at a cylinder block for communicating a crankcase with a cylinder head, a main separating passage formed in a head cover, an inflow passage drawing blow-by gas being transferred to the cylinder head through the main blow-by passage into the main separating passage, a sub-separator receiving a part of blow-by gas from the crankcase, and functioning to recollect the engine oil being collected to the crankcase, a sub-separating passage formed in the head cover, a sub-blow-by passage communicating the sub-separator with the sub-separating passage to transfer the blow-by gas passing via the sub-separator to the sub-separating passage, a main separator disposed in the head cover to separate and collect the engine oil from the blow-by gas passing through the main separating passage and the sub-separating passage, and a return outlet discharging the blow-by gas to an exterior.

### CROSS-REFERENCE TO RELATED APPLICATION

The present application claims priority to Korean Patent Application No. 10-2015-0177477, filed Dec. 11, 2015, the entire contents of which is incorporated herein for all purposes by this reference.

### BACKGROUND OF THE INVENTION

Field of the Invention

The present invention relates to an engine ventilation system. More particularly, to an engine ventilation system for resolving a pressure imbalance inside of the crankcase and improving performance to separate engine oil.

Description of Related Art

Generally, an internal combustion engine is a device for generating power by receiving air and fuel inside the engine and combusting the air and the fuel. When the internal combustion engine is operated, blow-by gas is generated in a compression stroke and an expansion stroke. Particularly, the blow-by gas is mostly generated in the compression stroke.

The blow-by gas is gas which is discharged to a crankcase through a gap between a cylinder and a piston in the compression stroke and the expansion stroke of the engine. The blow-by gas degrades engine oil which may cause rusting of an internal side of the engine. Further, an interior of a crankcase is under high pressure by the blow-by gas.

In order to prevent the aforementioned problem, a method of rapidly discharging the blow-by gas to the outside is used in the related art, but a method of resending the blow-by gas to a suction system has been recently used in order to prevent air pollution. As described above, a device for re-combusting the blow-by gas by circulating the blow-by gas to the combustion chamber so as to prevent the blow-by gas from being leaked to the outside of the crankcase is referred to as a crankcase ventilation system or an engine ventilation system.

In the general crankcase ventilation system, the blow-by gas is supplied from the crankcase to the cylinder head through a through-path formed between the crankcase and the cylinder head. In addition, the blow-by gas supplied to the cylinder head is supplied to an intake manifold, and is supplied to the combustion chamber through an intake port.

However, if engine oil is not removed as engine oil is vaporized from an oil pan by heat of blow-by gas and so on so that engine oil is contained in blow-by gas, a member such as a rubber joint, which is disposed at a passage for flowing blow-by gas being supplied to an intake manifold to a combustion chamber, is contacted with oil such that durability thereof may be deteriorated. Meanwhile, if blow-by gas excessively containing engine oil is supplied to the combustion chamber, pre-ignition may occur. In addition, in case that a pressure fluctuation inside of the crankcase is not resolved by the crankcase ventilation system, an engine may be stopped or explode by abnormal operation of the engine. Further, a pressure imbalance inside of the engine occurring by pressure fluctuation inside of the crankcase may deteriorate sealing performance of the engine. Particularly, in a two cylinder engine in which two pistons simultaneously move up and down, the deterioration may be amplified.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine ventilation system having advantages of improving performance to separate engine oil.

In addition, various aspects of the present invention are directed to providing an engine ventilation system having further advantages of resolving pressure imbalance in a crankcase.

According to various aspects of the present invention, an engine ventilation system may include a main blow-by passage formed at a cylinder block for communicating a crankcase with a cylinder head, a main separating passage formed in a head cover, an inflow passage drawing blow-by gas being transferred to the cylinder head through the main blow-by passage into the main separating passage, a sub-separator receiving a part of blow-by gas from the crankcase so as to separate and collect engine oil, and functioning to re-collect the engine oil being collected to the crankcase, a sub-separating passage formed in the head cover, a sub-blow-by passage communicating the sub-separator with the sub-separating passage to transfer the blow-by gas passing via the sub-separator to the sub-separating passage, a main separator disposed in the head cover so as to separate and collect the engine oil from the blow-by gas passing through the main separating passage and the sub-separating passage, and a return outlet discharging the blow-by gas passing via the main separator from the head cover to an exterior.

The main blow-by passage may be formed at both sides of the cylinder.

The sub-separator may be disposed at a side end of the crankcase on the cylinder block.

In a four cylinder engine, the sub-separator may receive a part of the blow-by gas from the crankcase communicated to first and second cylinders.

The engine ventilation system may further include drain passage formed at the head cover for engine oil being collected in the main separator to be drained to the cylinder head.

The engine oil passing through the drain passage may be transferred to the crankcase through the main blow-by passage.

The engine ventilation system may further include a check valve disposed at the drain passage to prevent the engine oil being drained through the drain passage from flowing backward.

The engine ventilation system may further include a return valve disposed at the return outlet for selectively opening and closing the return outlet.

When the return valve is opened, the blow-by gas may be transferred to the main separating passage and the sub-separating passage through the main blow-by passage and the sub-blow-by passage as low pressure of the main separating passage and the sub-separating passage may be generated.

The blow-by gas flowing out through the return outlet may be returned to a combustion chamber.

The main separating passage and the sub-separating passage may be partitioned from each other by a partition.

The partition may be formed such that both blow-by gasses passing through the main separating passage and the sub-separating passage become one flow before reaching the main separator.

A blow-by hole may be formed at a lower plate of the head cover such that the sub-blow-by passage is inserted thereinto to penetrate the lower plate of the head cover.

A gasket may be mounted along a circumference of the lower plate of the head cover, and a hole sealing portion, which is disposed along a circumference of the blow-by hole, may be formed at the gasket.

The gasket may be made of a rubber material.

The engine ventilation system may further include a breather housing disposed at an interior of the head cover and communicated with exteriors of the crankcase and the head cover.

A recirculation inlet which communicates with the crankcase and a recirculation outlet which communicates with the exterior of the head cover may be formed at the breather housing, and gas in the crankcase is circulated through the breather housing even while the return valve is closed.

A separator may be provided to separate fine engine oil from gas passing through the breather housing.

According to various aspects of the present invention, an engine ventilation system may include an inflow passage communicating a cylinder head and a head cover, a main blow-by passage formed at a cylinder block to communicate a crankcase with a cylinder head, a sub-separator, a sub-blow-by passage formed to transfer blow-by gas passing via the sub-separator to the head cover, and a main separator being disposed at the head cover and separating and collecting engine oil from the blow-by gas flowed into the head cover through the inflow passage via the main blow-by passage and the blow-by gas flowed into the head cover through the sub-blow-by passage.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a basic schematic diagram of an engine ventilation system according to various embodiments of the present invention.

FIG. 2 is an additional schematic diagram of an engine ventilation system according to various embodiments embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

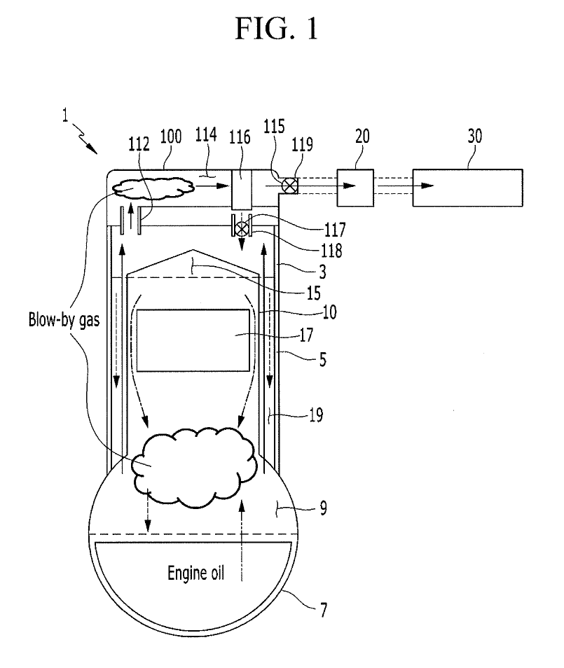

FIG. 1 is a basic schematic diagram of an engine ventilation system according to various embodiments of the present invention.

As shown in FIG. 1, an engine ventilation system 1 according to various embodiments of the present invention includes a main blow-by passage 19, an inflow passage 112, a main separating passage 114, a main separator 116, a drain passage 118, a check valve 117, a return outlet 119, and a return valve 115.

The engine ventilation system 1 is provided to circulate blow-by gas which flows out from a combustion chamber 15 to a crankcase 9 through a gap between a cylinder 10 and a piston 17 so as to supply the blow-by gas to the combustion chamber 15. In FIG. 1, flow of blow-by gas passing through the gap between the cylinder 10 and the piston 17 is illustrated as alternate long and short dash lines (one point chain lines).

Herein, the cylinder 10 which is formed or disposed at a cylinder block 5, the combustion chamber 15 which is formed by coupling a cylinder head 3 with the cylinder block 5 such that compression and explosion of a mixture are performed, the piston 17 which makes a reciprocating motion in the cylinder 10, the crankcase 9 which is formed by coupling the cylinder block 5 with an oil pan 7 such that a crankshaft is disposed therein, and the cylinder head 3, the cylinder block 5, and the oil pan 7 which compose the engine are well known to a person of ordinary skill in the art, so detailed descriptions thereof will be omitted. In FIG. 1, a boundary between the cylinder head 3 and the cylinder block 5 and a boundary between the cylinder block 5 and the oil pan 7 are illustrated as dotted lines.

The main blow-by passage 19 is formed at the cylinder block 5 so as to communicate the crankcase 9 with the cylinder head 3. In addition, the main blow-by passage 19 may be formed at a circumference or both sides of the cylinder 10. Further, blow-by gas moves from the crankcase 9 to the cylinder head 3 through the main blow-by passage 19. In FIG. 1, flow of blow-by gas passing through the main blow-by passage 19 is illustrated as solid lines.

Meanwhile, blow-by gas, which flows out to the crankcase 9 and then stays there, generates heat having a high temperature, and engine oil stored in the oil pan 7 is vaporized by this heat. In addition, the vaporized engine oil is contained in blow-by gas. In FIG. 1, flow of engine oil being vaporized from the oil pan 7 is illustrated as two point chain lines.

The inflow passage 112 is formed at a head cover 100 so as to inhale blow-by gas, which is moved to the cylinder head 3 through the main blow-by passage 19, into the head cover 100. Herein, basic function and composition of the head cover 100 which is an upper cover of the cylinder head 3 are well known to a person of ordinary skill in the art, so detailed description thereof will be omitted.

The main separating passage 114 is formed in the head cover 100. The main separating passage 114 communicates with the inflow passage 112. That is, blow-by gas passing through the inflow passage 112 flows into the main separating passage 114.

The main separator 116 is disposed at the main separating passage 114. In addition, the main separator 116 functions to separate engine oil from blow-by gas passing through the main separating passage 114 and collect the engine oil.

The drain passage 118 is formed at the head cover 100 such that the engine oil collected in the main separator 116 is drained to the cylinder head 3. Engine oil passing through the drain passage 118 is transferred to the crankcase 9 through the main blow-by passage 19 which communicates the cylinder head 3 with the crankcase 9 and then is re-collected to the oil pan 7. In FIG. 1, flow of engine oil which sequentially flows via the drain passage 118, the main blow-by passage 19, and the crankcase 9 so as to be re-collected to the oil pan 7 is illustrated as dotted lines.

The check valve 117 is dispose at the drain passage 118. The check valve 117 functions to prevent backflow of engine oil being drained from the main separator 116 to the cylinder head 3 through the drain passage 118.

The return outlet 119 communicates the main separating passage 114 with an exterior of the head cover 100. The return outlet 119 discharges blow-by gas passing through the main separating passage 114 to the exterior of the head cover 100.

The return valve 115 is disposed at the return outlet 119 so as to selectively open/close the return outlet 119. When the return valve 115 is opened, an interior of the main separating passage 114 becomes low pressure so that blow-by gas is drawn into the interior of the main separating passage 114 through the inflow passage 112. Further, when the return valve 115 is opened, blow-by gas is transferred to an intake manifold 30 via a surge tank 20 which communicates with the return outlet 119 and is ultimately returned to the combustion chamber 15.

The intake manifold 30 which is a passage for guiding a mixture to each cylinder and the surge tank 20 which is disposed between the intake manifold 30 and a throttle valve so as to control pulsation and interference of intake air are well known to a person of ordinary skill in the art, so detailed description thereof will be omitted.

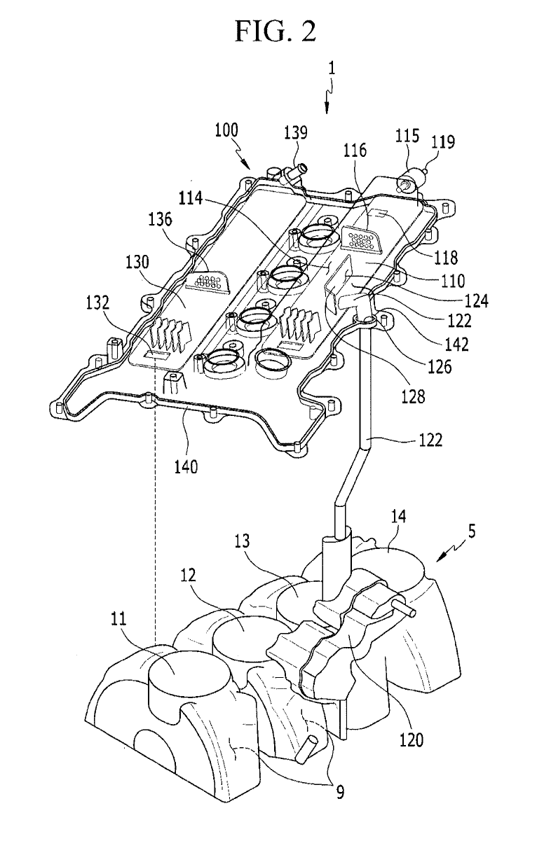

FIG. 2 is an additional schematic diagram of an engine ventilation system according to various embodiments of the present invention.

As shown in FIG. 2, an engine ventilation system 1 according to various embodiments of the present invention includes a main returner 110, a pre-separator 120, a sub-blow-by passage 122, a sub-separating passage 124, a blow-by hole 126, a breather housing 130, a recirculation inlet 132, a recirculation outlet 139, and a gasket 140.

The main returner 110 is mounted to a lower plate of the head cover 100. The inflow passage 112, the main separating passage 114, the main separator 116, and the drain passage 118 are constituent elements which compose the main returner 110 and are disposed in the main returner 110. The inflow passage 112 and the drain passage 118 are formed at the lower plate of the head cover 100 at an interior of the main returner 110. The return outlet 119 communicates the interior of the main returner 110 with the exterior of the head cover 100.

The pre-separator 120 is disposed on a side end of the crankcase 9 at the cylinder block 5. In addition, the pre-separator 120 receives a part of blow-by gas from the crankcase 9 so as to separate and collect engine oil contained in blow-by gas. Further, the pre-separator 120 re-collects the collected engine oil into the crankcase 9. That is, the pre-separator 120 functions as an ancillary separator (sub-separator) which is additionally provided, different from the main separator 116 of the main returner 110. In case of a four cylinder engine having first, second, third, and fourth cylinders 11, 12, 13, and 14, the pre-separator 120 is disposed at side ends of the first cylinder 11 and the second cylinder 12, and the pre-separator 120 receives a part of blow-by gas from the crankcase 9 which communicates with the first cylinder 11 and the second cylinder 12 so as to separate and collect engine oil and then re-collects the collected engine oil to the crankcase 9.

The sub-blow-by passage 122 is formed at the cylinder block 5 and the cylinder head 3 so as to communicate interiors of the pre-separator 120 and the main returner 110. Blow-by gas from which engine oil is firstly separated is transferred into the main returner 110 through the sub-blow-by passage 122. Movement of blow-by gas through the sub-blow-by passage 122 may be performed as the interior of the main returner 110 becomes low pressure by opening the return valve 115.

The sub-separating passage 124 is provided to be different from the main separating passage 114 which is formed in the main returner 110 by a partition 128. That is, the interior of the main returner 110 is partitioned to the main separating passage 114 and the sub-separating passage 124 by the partition 128. Blow-by gas passing through the sub-blow-by passage 122 sequentially flows via the sub-separating passage 124 and the main separator 116 so as to be discharged through the return outlet 119. The main separating passage 114 and the sub-separating passage 124 are formed such that both blow-by gasses are become one flow before reaching the main separator 116. That is, the partition 128 is only extended to a front end of the main separator 116 in a circulation direction of blow-by gas.

The blow-by hole 126 is formed at the lower plate of the head cover 100. The sub-blow-by passage 122 is inserted into the blow-by hole 126 so as to penetrate the head cover 100.

The breather housing 130 is disposed in the head cover 100. The breather housing 130 communicates with the crankcase 9 so as to maintain balance of pressure of the crankcase 9. The breather generally means a hole which is bored to a member such as the crankcase 9 so that air flows out from the member or flows in and out, and the breather housing 130 is configured so that the interior thereof communicates with the crankcase 9 through the recirculation inlet 132 and communicates with the exterior of the head cover 100 through the recirculation outlet 139. Balance of pressure of the crankcase 9 is maintained as a gas in the crankcase 9 is circulated through the breather housing 130 even while the return valve 115 is closed such that ventilation of blow-by gas by the main returner 110 is not performed.

Another separator 136 which separates fine engine oil droplets from a gas passing through the breather housing 130 may be disposed at the interior of the breather housing 130.

The gasket 140 is mounted along a circumference of the lower plate of the head cover 100. A hole sealing portion 142 which is disposed along a circumference of the blow-by hole 126 is formed at the gasket 140. The gasket 140 may be made of a rubber material.

The hole sealing portion 142 functions to prevent air-tightness performance from being deteriorated by the blow-by hole 126 which is formed at the lower plate of the head cover 100. It is well known to a person of ordinary skill in the art that the gasket 140 is provided for ensuring air-tightness.

According to various embodiments of the present invention, engine oil separating performance can be improved as engine oil is separated twice from a part of a blow-by gas. In addition, it is possible to separate engine oil in the state of blow-by gas having a high temperature by the pre-separator 120 which is disposed at the cylinder block. Further, pressure of the crankcase 9 can be maintained in equilibrium by circulating a gas remaining in the crankcase 9 through the breather housing 130 even while blow-by gas is not transferred to the main returner 110.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine ventilation system comprising:
a main blow-by passage formed at a cylinder block for communicating a crankcase with a cylinder head;
a main separating passage formed in a head cover;
an inflow passage drawing blow-by gas being transferred to the cylinder head through the main blow-by passage into the main separating passage;
a sub-separator receiving a part of blow-by gas from the crankcase to separate and collect engine oil, and functioning to re-collect the engine oil being collected to the crankcase;
a sub-separating passage formed in the head cover;
a sub-blow-by passage communicating the sub-separator with the sub-separating passage to transfer the blow-by gas passing via the sub-separator to the sub-separating passage;
a main separator disposed in the head cover to separate and collect the engine oil from the blow-by gas passing through the main separating passage and the sub-separating passage; and
a return outlet discharging the blow-by gas passing via the main separator from the head cover to an exterior.

2. The engine ventilation system of claim 1, wherein the main blow-by passage is formed at both sides of the cylinder.

3. The engine ventilation system of claim 1, wherein the sub-separator is disposed at a side end of the crankcase on the cylinder block.

4. The engine ventilation system of claim 3, wherein, in a four cylinder engine, the sub-separator receives a part of the blow-by gas from the crankcase communicated to first and second cylinders.

5. The engine ventilation system of claim 1, further comprising a drain passage formed at the head cover for engine oil being collected in the main separator to be drained to the cylinder head.

6. The engine ventilation system of claim 5, wherein the engine oil passing through the drain passage is transferred to the crankcase through the main blow-by passage.

7. The engine ventilation system of claim 6, further comprising a check valve disposed at the drain passage to prevent the engine oil being drained through the drain passage from flowing backward.

8. The engine ventilation system of claim 1, further comprising a return valve disposed at the return outlet for selectively opening and closing the return outlet.

9. The engine ventilation system of claim 9, wherein, when the return valve is opened, the blow-by gas is transferred to the main separating passage and the sub-separating passage through the main blow-by passage and the sub-blow-by passage as low pressure of the main separating passage and the sub-separating passage is generated.

10. The engine ventilation system of claim 1, wherein the blow-by gas flowing out through the return outlet is returned to a combustion chamber.

11. The engine ventilation system of claim 1, wherein the main separating passage and the sub-separating passage are partitioned from each other by a partition.

12. The engine ventilation system of claim 12, wherein the partition is formed such that both blow-by gasses passing through the main separating passage and the sub-separating passage become one flow before reaching the main separator.

13. The engine ventilation system of claim 1, wherein a blow-by hole is formed at a lower plate of the head cover such that the sub-blow-by passage is inserted thereinto to penetrate the lower plate of the head cover.

14. The engine ventilation system of claim 14, wherein a gasket is mounted along a circumference of the lower plate of the head cover, and a hole sealing portion, which is disposed along a circumference of the blow-by hole, is formed at the gasket.

15. The engine ventilation system of claim 15, wherein the gasket is made of a rubber material.

16. The engine ventilation system of claim 1, further comprising a breather housing disposed at an interior of the head cover and communicated with exteriors of the crankcase and the head cover.

17. The engine ventilation system of claim 17, wherein a recirculation inlet which communicates with the crankcase and a recirculation outlet which communicates with the exterior of the head cover are formed at the breather housing, and gas in the crankcase is circulated through the breather housing even while the return valve is closed.

18. The engine ventilation system of claim 17, wherein a separator is provided to separate fine engine oil from gas passing through the breather housing.

19. An engine ventilation system comprising:
an inflow passage communicating a cylinder head and a head cover;
a main blow-by passage formed at a cylinder block to communicate a crankcase with a cylinder head;
a sub-separator;
a sub-blow-by passage formed to transfer blow-by gas passing via the sub-separator to the head cover; and
a main separator being disposed at the head cover and separating and collecting engine oil from the blow-by gas flowed into the head cover through the inflow passage via the main blow-by passage and the blow-by gas flowed into the head cover through the sub-blow-by passage.
